(19) United States
(12) Patent Application Publication
(10) Pub. No.: US 2014/0068165 A1
(43) Pub. Date: Mar. 6, 2014

(54) SPLITTING A REAL-TIME THREAD BETWEEN THE USER AND KERNEL SPACE

(71) Applicants: Thierry DeCorte, Laval (CA); Donald Stevenson, Kirkland (CA)

(72) Inventors: Thierry DeCorte, Laval (CA); Donald Stevenson, Kirkland (CA)

(73) Assignee: Accedian Networks Inc., Saint-Laurent (CA)

(21) Appl. No.: 13/605,648

(22) Filed: Sep. 6, 2012

(51) Int. Cl. G06F 12/00

(52) U.S. Cl. 711/104; 711/E12.001

(57) ABSTRACT

A method is provided for exchanging large amounts of memory within an operating system containing consumer and producer threads located in a user space and a kernel space, by controlling ownership of a plurality of RAM banks shared by multiple processes or threads in a consumer-producer relationship. The method includes sharing at least two RAM banks between a consumer process or thread and a producer process or thread, thereby allowing memory to be exchanged between said consumer process or thread and said producer process or thread, and alternately assigning ownership of a shared RAM bank to either said consumer process or thread or said producer process or thread, thereby allowing said producer process or thread to insert data into said shared RAM bank and said consumer process or thread to access data from said shared RAM bank.

### FIELD OF THE INVENTION

Application of the Enhanced Inter-Process Communication between user space applications and operating system kernel modules, device drivers and applications to split a real-time thread between the user space and kernel space.

### BACKGROUND OF THE INVENTION

In computer science, a thread of execution is the smallest unit of processing that can be scheduled by an operating system. A thread is a lightweight process and the implementation differs from one operating system to another. In most cases, a thread is contained inside a process. Multiple threads existing within the same process share resources such as memory; different processes do not share these resources. The threads of a process share its code and its context (the values that its variables reference at any given moment).

In computing, Inter-process communication (IPC) is a set of methods for the exchange of data among multiple threads in one or more processes. Processes may be running on one or more computers connected by a network. IPC methods are divided into methods for message passing, synchronization, shared memory, and remote procedure calls (RPC). The method of IPC used may vary based on the bandwidth and latency of communication between the threads, and the type of data being communicated.

Input and output (I/O) operations on a computer can be extremely slow compared to the processing of data. An approach to I/O would be for a service to make an I/O function call and then wait for it to complete, but such an approach (called synchronous I/O or blocking I/O) would block the progress of a application while waiting, leaving system resources idle. When a service makes many I/O operations, this means that the processor can spend almost all of its time idle waiting for I/O operations to complete. Alternatively, it is possible for a service to make a function call and then continue processing. This means that it does not require the I/O to have completed processing, and the application can be told later, usually via a message, that the operation is complete. This approach is called asynchronous or non-blocking input/output.

Conventional operating systems can be divided into two layers, user space and kernel space. Application code resides in user space, while the underlying facilities of the operating system reside in the kernel space. The kernel is a bridge between applications and the actual data processing done at the hardware level. The kernel's responsibility is to manage the communication between hardware and software components. The kernel can provide the lower-level abstraction layer for the resources (especially processors and I/O devices) that application software must control to perform its function. It typically makes these facilities available to application processes through IPC mechanisms and system calls. The kernel handles sensitive resources and implements the security and reliability barriers between applications; for this reason, user space applications are prevented by the operating system from directly accessing kernel resources.

User space applications typically make requests to the kernel by means of system calls, whose code lies in the kernel layer. System calls are sometimes inappropriate for accessing devices. User space applications may need to communicate directly with devices and operating systems support diverse devices, many of which offer a large collection of operations. Not all operations may be foreseen, and as a consequence it is difficult for a kernel to provide system calls for all the operations.

To solve this problem, the kernel is designed to be extensible, and accepts an extra module called a device driver which runs in kernel space and can directly address the device. An IOCTL (input/output control) is a single system call by which user space may communicate with device drivers. The kernel can then allow the user space to access a device driver without knowing anything about the facilities supported by the device, and without needing a large collection of system calls.

When a computer program needs to connect to a local or wide area network such as the Internet, it uses a software component called a socket. The socket opens the network connection for the program, allowing data to be read and written over the network. Sockets are a key part of most operating systems. They make it easy for software developers to create network-enabled programs. Instead of constructing network connections from scratch for each application they write, developers can include sockets in their programs. The sockets allow the programs to use the operating system's built-in commands to handle networking functions. Because they are used for a number of different network protocols (i.e. HTTP, FTP, telnet, and e-mail), many sockets can be open at one time. IPC flows use sockets. A socket API is an application programming interface (API), usually provided by the operating system, that allows application programs to control and use network sockets. Internet socket APIs are usually based on the Berkeley sockets standard. The Berkeley sockets is a computing library with an application programming interface (API) for internet sockets and Unix domain sockets used for inter-process communication. Socket APIs take socket types and socket network protocols as parameters. A socket address is the combination of an IP address and a port number. Based on this address, sockets deliver incoming data packets to the appropriate application process or thread.

Sockets allow the kernel to send notifications to a user space application. Socket based mechanisms allow the applications to listen on a socket, and the kernel sends them messages at any time; the user space and kernel space are equal partners.

In order to meet the performance requirements of protocols operating at high speeds (such as Ethernet at 10 Gbps or 100 Gbps), while preserving the native services of an operating system (such as, but not limited to, Linux) and more specifically the delineation of functions and rights for processes operating in the user space as well as kernel functions, modules, devices drivers and/or applications, it is necessary to rethink how popular Inter-Process Communication (IPC) techniques can be used (and implemented) more efficiently.

Well-known techniques and tools available to user space applications and found in popular operating systems (such as Berkeley Sockets) should be preserved to leverage existing applications and know-how of a technical team.

Whenever a service reads or writes data to a socket, it's using a system call. This call (such as read or write) crosses the boundary of the user space application to the kernel. Additionally, prior to getting to the kernel, the call goes through the C library to a common function in the kernel (system_call( )). From system_call( ), this call gets to the file system layer, where the kernel determines what type of device it's dealing with. Eventually, the call gets to the sockets layer, where data is read or queued for transmission on the socket (involving a data copy). This process illustrates that the system call operates not just in the application and kernel domains but through many levels within each domain.

Typical IPC services to applications in the user space are extended to the kernel space to reduce the overhead when a service needs to interface with other services offered by the kernel. Because of the sensitivity of the services performed in the kernel space, it is imperative that while the native semantics of popular IPC mechanism is preserved, that it never results in a blocked (or sleeping) event while operating in kernel mode.

By splitting a real-time (non-blocking) thread between the user space and the kernel space and leveraging the enhanced IPC methods, (including the enhanced popular Berkeley Sockets interface), it is possible to preserve the semantic of a typical real-time user space thread while taking advantage of the performance enhancements that can be achieved by relying on the new enhanced IPC methods.

Multiple variations of operating systems are known to those familiar with the technology. The performance level that needs to be reached to support newer protocols such as Service OAM cannot be achieved without a major increase in the cost of the underlying hardware platform.

The ITU (International Telecommunication Union) is the United Nations specialized agency for information and communication technologies (ICTs). ITU standards (called Recommendations) are fundamental to the operation of ICT networks. ITU-T Y.1731 performance monitoring provides standards-based Ethernet performance monitoring that encompasses the measurement of Ethernet frame delay, frame delay variation, and frame loss and throughput. The Service OAM framework defines a number of functions for connectivity verification as well as performance monitoring.

Distributed OS solutions are designed to communicate between host CPUs running basically the same OS. This approach does not work when using programmable devices (such as FPGA) that do not operate under a traditional OS.

Even with some of the most recent enhancements to operating systems, the context switching overhead is still too high, especially when building cost sensitive platforms. As such, the embodiment shows that it can deliver the required performance improvements (and overhead reduction) without the need to modify the underlying hardware platform.

For instance, recently developed protocols (such as Y.1731) require the ability to process Service OAM messages every 3.33 msec.

This is a higher rate of scheduling than what is permissible with a typical operating system (usually in the range of 10-20 msec).

The use of a shared RAM between the user space and kernel space threads coupled with a shared memory RAM bank or bank management method helps to improve the performance by eliminating the overhead associated with the file system method inherent to operating systems. The use of a shared memory RAM bank helps to reduce and sometimes eliminate the need to copy memory content between the user space and kernel space but requires strong synchronization between the threads or processes in the user space and in the kernel space. Semaphores are often used to enforce the strict synchronization required to efficiently and reliably use shared memory techniques.

### SUMMARY OF THE INVENTION

In accordance with one embodiment, a method is provided for exchanging large amounts of memory within an operating system containing consumer and producer threads located in a user space and a kernel space, by controlling ownership of a plurality of RAM banks shared by multiple processes or threads in a consumer-producer relationship. The method includes sharing at least two RAM banks between a consumer process or thread and a producer process or thread, thereby allowing memory to be exchanged between said consumer process or thread and said producer process or thread, and alternately assigning ownership of a shared RAM bank to either said consumer process or thread or said producer process or thread, thereby allowing said producer process or thread to insert data into said shared RAM bank and said consumer process or thread to access data from said shared RAM bank. The shared RAM banks may be located in a RAM region shared by said user space and kernel space, with each said RAM bank containing definitions including a bank identifier comprised of a base address or a numerical index, an owner flag used to identify the process or thread currently owning said bank, and a data region structured to allow memory exchange.

In one implementation, the consumer process or thread assigns ownership of the shared RAM bank to the producer process or thread, such as (1) by setting the current memory bank identifier to a new value via an automatic update, or (2) based on an external event comprising the expiration of a reporting timer initiated by the consumer process or thread and receiving an asynchronous event notification upon expiration of the reporting time, or a request from a management thread or process. The producer process or thread may detect assignment of the shared RAM bank by retrieving the bank identifier and comparing the bank identifier against a cached copy of the previously used bank identifier, or detecting whether the bank identifier has changed, and resetting the bank index to the beginning of the data region of the bank if the bank identifier has changed.

In another implementation, the producer process or thread assigns ownership of the shared RAM bank to the consumer process or thread. The assignment may be based on an external event comprising a timer initiated by the producer process or thread, an asynchronous event notification sent from the producer process or thread to the consumer process or thread, or a request from a management thread or process. The consumer process or thread may detect the assignment of said shared RAM bank by receiving an asynchronous notification from a producer process or thread, accessing the bank identifier, or resetting the bank index to the beginning of the data region of the bank.

### BRIEF DESCRIPTION OF THE DRAWINGS

The invention may best be understood by reference to the following description taken in conjunction with the accompanying drawings.

FIG. 1 shows an application in the user space with a blocking thread and a non-blocking thread.

FIG. 2 shows how a real-time thread can be split between the user space and the kernel space.

FIG. 3 illustrates the organization of a shared memory ram bank.

FIG. 4 shows a simpler organization of a shared memory ram bank.

FIG. 5 illustrates a producer—consumer model to share a memory RAM bank.

FIG. 6 illustrates another producer—consumer model to share a memory RAM bank.

### DETAILED DESCRIPTION OF ILLUSTRATED EMBODIMENTS

Although the invention will be described in connection with certain preferred embodiments, it will be understood that the invention is not limited to those particular embodiments. On the contrary, the invention is intended to cover all alternatives, modifications, and equivalent arrangements as may be included within the spirit and scope of the invention as defined by the appended claims.

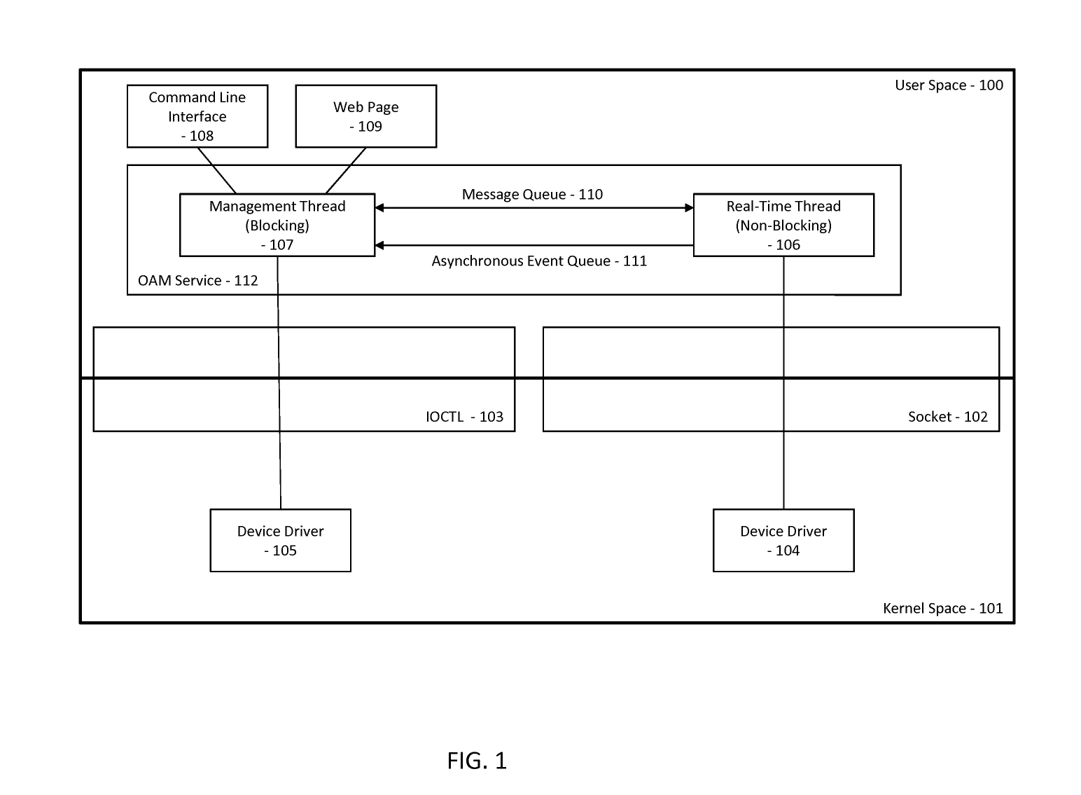

FIG. 1 shows the basic blocks of the current state of the art for an application 112 in the user space 100 that is split between two distinct threads. A management thread 107 interfaces with a command line interface module 108 and a web page module 109 for the purpose of offering management information and control for the OAM services or functions offered by application 112.

A command-line interface (CLI) 108 is a means of interaction between a human user and the application offering the OAM service 112, where the user passes commands in the form of a line of text (a command line) to the OAM service 112. A Web Page 109 can also be used to interact between a human user and the OAM service 112.

The management thread 107 can be blocked waiting on input from modules 108 and 109 or from a device driver 105 in the kernel space 101. The interface to the device driver 105 is typically achieved via services of the kernel 101, including but not limited to a generic IOCTL interface 103. The application 112 in the user space 100, furthermore contains a real-time thread 106 that cannot be blocked. Thread 106 also requires services from a device driver 104 in the kernel space 101 via the popular sockets interface 102 found in most contemporary operating systems.

The management thread 107 and the real-time thread 106 communicate via a message passing technique. A message queue 110 is used by the management thread 107 as a bidirectional communication channel to control or retrieve information and data from the real-time thread 106. Since the real-time thread 106 cannot be blocked, it uses an asynchronous event queue 111 to notify the management thread 107 that new information is available for retrieval via the message queue 110.

IOCTL 103 is a system call for device-specific input/output operations. For example, under the UNIX operating system, an IOCTL call takes as parameters:

1. an open file descriptor (fd): an abstract indicator for accessing a file or a device driver.

2. a request code number (documented by the device driver 105 and provided in a header file).

3. an integer value or a pointer to data (either going to the driver, coming back from the driver, or both)

Generally, a file descriptor (fd) is an index for an entry in a kernel-resident data structure containing the details of all open files. The kernel generally dispatches an IOCTL 103 call straight to the device driver 105, which can interpret the request code number and data in whatever way required.

A socket 102 is a data communications endpoint for exchanging data between processes.

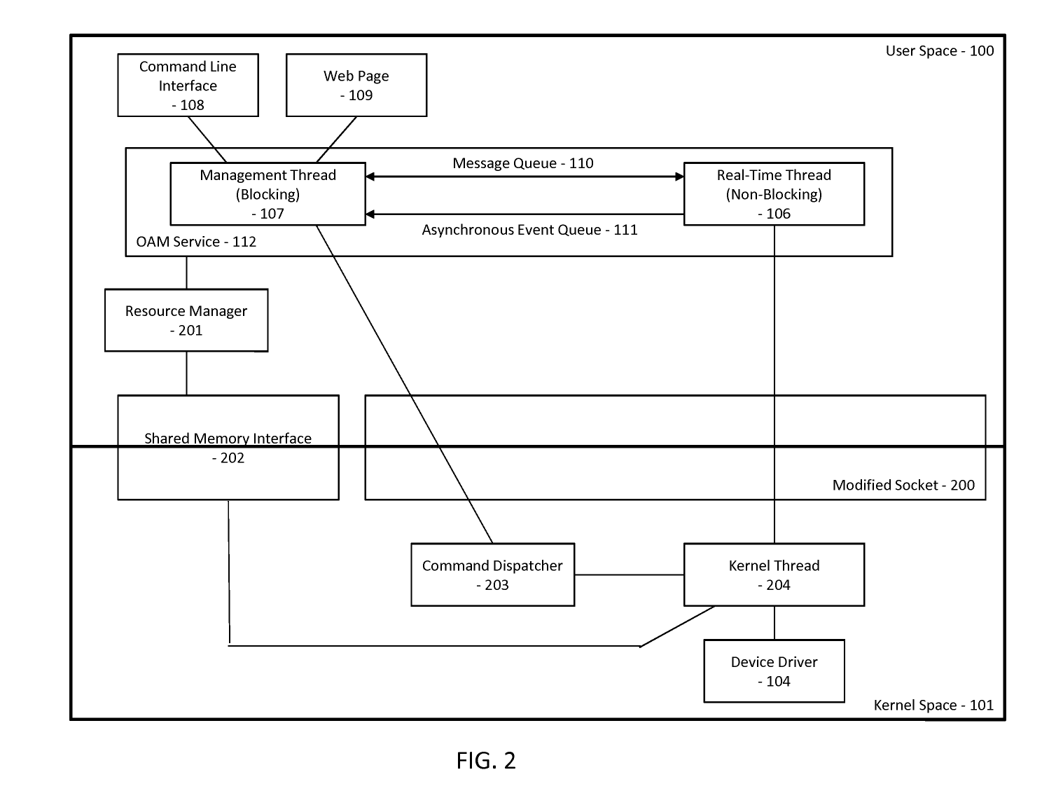

The architecture described in FIG. 1 can yield improved performance when taking advantage of the embodiment, for instance for the purpose of performing some of the real-time tasks originally performed by real-time thread 106 in the kernel space 101 to reduce the overhead associated with context switching and other operating system calls or functions. This is illustrated by FIG. 2.

A new modified socket interface 200 is defined to allow the use of sockets for non-blocking communication such as event passing between user space 100 and kernel space 101.

Kernel resources can be managed from the management thread 107 while they are used by kernel side threads. This is particularly useful when allocating resources to be used to service other remote devices and/or applications. Relying on a management thread 107 is also useful to synchronize the allocation and management of user space 100 resources that are needed for the overall function traditionally performed by the pair of threads (106, 107) in the user space 100. The notion of a generic command dispatcher 203 interfacing via the modified socket 200 (based on Berkeley Sockets) interface helps to further reduce the overhead resulting from the use of a file descriptor method common to most operating systems.

In this embodiment, the original real-time thread 106 in user space 100 is improved by preserving the original message queue 110 and the asynchronous event queue 111 with the management thread 107 while displacing other real-time functions to a kernel thread 204 to reduce the operating system overhead and achieve better overall performance. The asynchronous event queue 111 between the management thread 107 and the real-time thread 106 in the user space is preserved, but the role of the real-time thread 106 is enhanced to also act as a relay for event notifications that originate from the kernel thread 204 in order to preserve the original communications means between the management thread 107 and the real-time thread 106. The message queue 110 is preserved between the management thread 107 and the real-time thread 106, but larger data structures are more efficiently handled by the shared memory RAM interface 202.

The shared memory RAM interface 202 consists of at least 2 banks of shared memory RAM region that are structured to meet the specific needs of the service. For instance, the reporting of performance measurements in the context of an application offering OAM services 112 can result in data structures that are too large to efficiently be used over the modified sockets interface 200.

The notion of a shared memory interface 202 with a bank switching method is useful when large amount of memory needs to be exchanged between the threads in the user space 100 and threads in the kernel space 101. It also helps to eliminate the data copying inherent to sockets and other file-system based interfaces.

The shared memory interface 202 consists of at least 2 banks of memory region that are structured to meet the specific needs of the service. For instance, the reporting of performance measurements in the context of an OAM service 112 function can result in data structures that are too large to efficiently be used over the popular Berkeley Sockets interface.

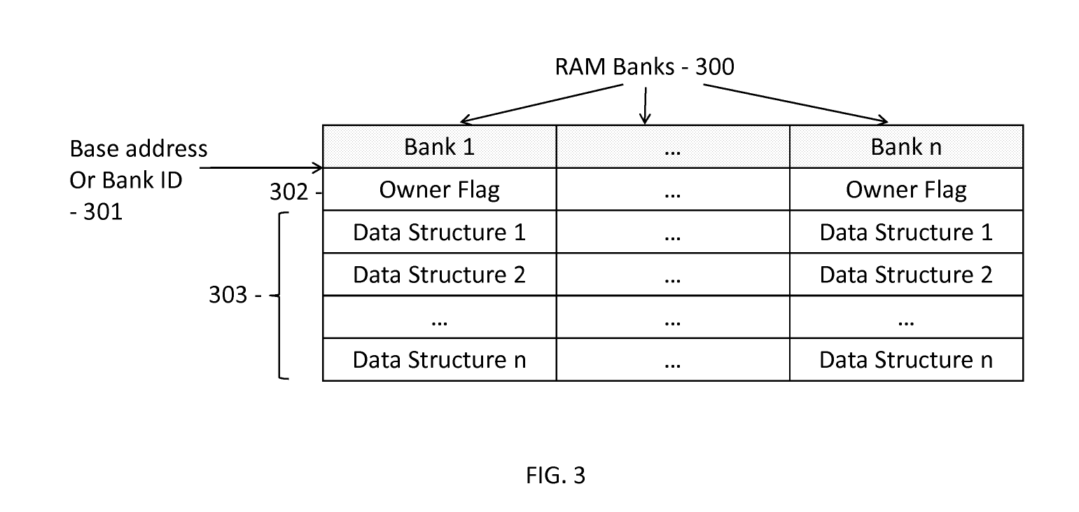

FIG. 3 describes the shared memory interface 202. Each of the RAM (Random Access Memory) banks 300 is uniquely identified by a base address or bank ID 301 of contiguous shared memory addressable from user space 100 and kernel space 101 threads. The owner flag 302 of each shared memory RAM bank 300 is set to indicate which thread is the owner of a specific shared memory RAM bank 300. The ownership can be generalized to either a Producer or a Consumer. The owner of a shared memory RAM bank has full write access to the shared memory RAM bank 300. ConsumerConsumerThe Consumer has Read and Write Access as long as it is declared as the current owner of the shared memory RAM bank. While the definition of a data structure 303 is totally flexible, one familiar with the art should expect that a timestamp or other status flag can be used to indicate the state of a given data structure 303 in the shared memory RAM bank 300.

The change of ownership of a shared memory RAM bank 300 can be either the control of the Producer or under the control of the Consumer. Unlike traditional implementations, there is no use of semaphores or similar techniques to ensure exclusive and synchronized control of a shared memory RAM bank 300 between a plurality of processes or threads. In one embodiment, a consumer process or thread determines on its own that it needs to obtain ownership of a shared memory RAM bank 300 currently in use by a producer process or thread. In another embodiment, the producer process or thread is responsible for determining when to transfer ownership of a shared memory RAM bank 300 to a consumer process or thread.

Once the Consumer is done accessing the content of a shared memory RAM bank 300 it owns, it sets the owner flag 302 back to the Producer to indicate that the shared memory RAM bank 300 is ready to be used again by the Producer. The selection of an available shared memory RAM bank 300 by a producer process or thread can take many forms such as setting a flag at a specific offset in the shared memory RAM bank 300 (for instance when there are only 2 banks), by using a linked list of base address of available shared memory RAM banks 300 or by directly polling the ownership of a shared memory RAM bank 300. Yet another method would be for a consumer process or thread to generate an asynchronous notification to a producer thread or process with the base address or bank ID 302 of a shared memory RAM bank 300 to indicate it is now available.

All owner flag 302 updates should be done via an automatic update to avoid potential issues if there is an interrupt or an asynchronous event.

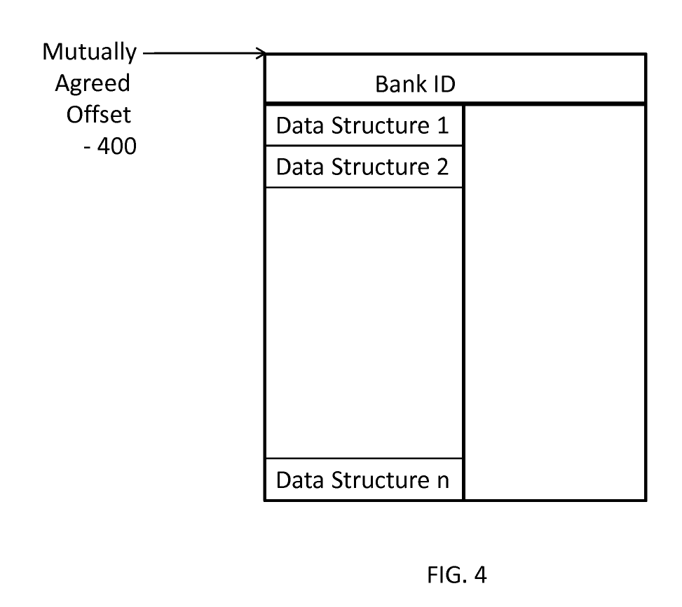

As seen in FIG. 4, in a simpler variation, where only 2 Shared Memory Data banks are needed, the owner flag 302 can be eliminated and replaced by a single Bank ID field at a mutually agreed offset 400 (for instance byte at offset 0 from the base address of the Shared Memory) that is used by the Producer to identify which bank to use. Under this simplified variation, the Consumer will always use the other Shared Memory Bank not currently in use by the Producer.

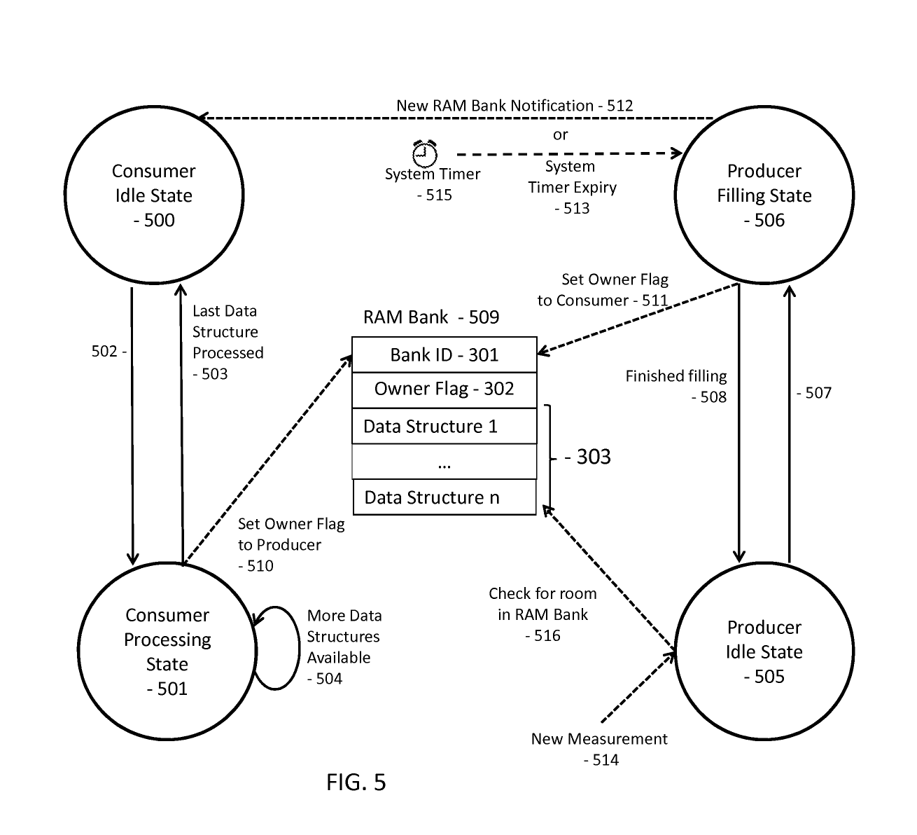

FIG. 5 shows a state diagram for a producer and consumer. This shows the producer receiving a new measurement 514, filling a shared memory RAM bank 509, and notifying 512 the consumer that a shared memory RAM bank 509 is ready with data.

A producer thread (in Kernel Space 101) receives a new measurement 514 in producer idle state 505. It checks for room in the RAM Bank 516 with an owner flag of producer, and if there is room, it selects a RAM Bank 509, and it transitions 507 to producer filling state 506. The producer can write to the shared memory RAM bank 509 as long as it is the current owner. Since the memory has a finite size, the producer is responsible for making sure that it does not exceed the storage capacity. It adds all the necessary data structures 303 to RAM bank 509, and then sets the owner flag 302 to consumer 511. At this point one of two things can happen; either the producer sends a new asynchronous RAM bank 509 notification 512 to the consumer, or a system timer 515 generates an asynchronous timer expiry message 513 to the consumer. The system timer 515 can be set to any reasonable value. The producer then transitions back to producer idle state 505 waiting for the next new measurement 514 to become available.

A consumer process or thread (whether in user space 100 or kernel space 101) is in consumer idle state 500 waiting for a notification (from the Producer 512 or via timer expiry 513) so that it can access the content of the shared memory RAM bank 509. Such a notification is asynchronously received to optimize the use of resources. An alternate implementation may rely on active polling or other notification methods.

Once a Consumer has gained ownership of a shared memory RAM bank 509 by receiving an asynchronous notification 512 or 513 it transitions 502 to consumer processing state 501. As the owner of a shared memory RAM bank 509, it has free read and write access to that shared memory RAM bank 509, and accesses the data structures 303 one by one 504 until the last data structure 303 is processed, and it transitions 503 back to consumer idle state 500. At this point the consumer is done with the shared memory RAM bank 509 and sets the owner flag 302 back to the producer.

Upon assigning ownership of a shared memory RAM bank 509 to the consumer, the producer shall select another shared memory RAM bank for use. It is therefore important for the consumer to free a shared memory RAM bank 509 as quickly as possible to avoid starving the producer.

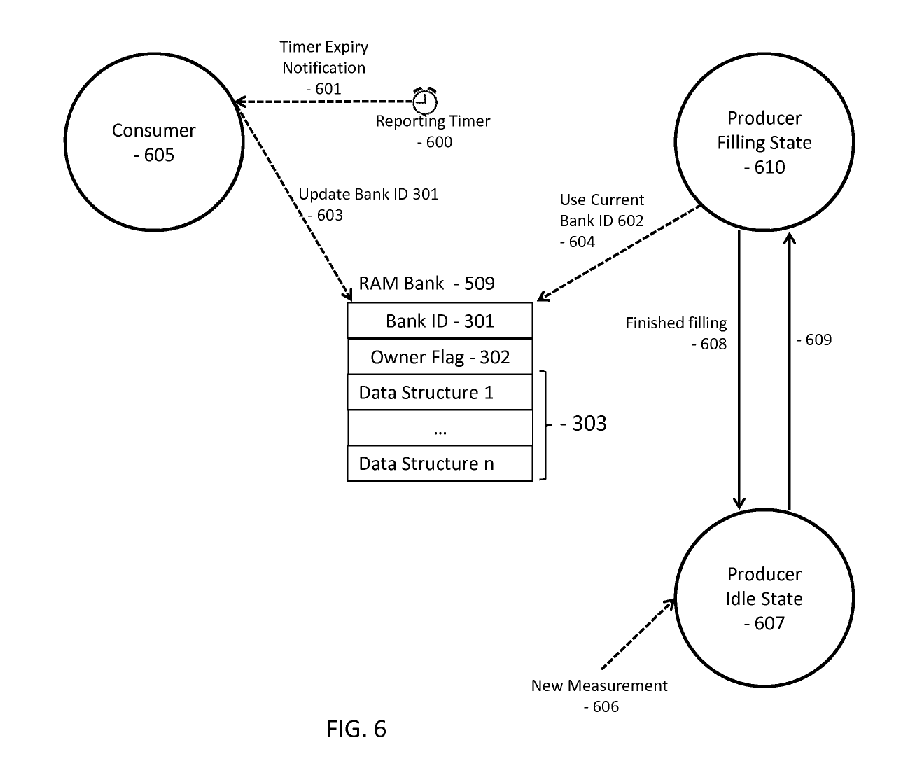

Alternately the consumer can control the producer. This is shown in FIG. 6. This is useful when the consumer is responsible for deciding which shared memory RAM bank 509 shall be used by the producer. A consumer process or thread 605 needs to wait for a reporting timer 600 to elapse. Upon receiving the asynchronous notification 601 that the reporting timer 600 has elapsed, the consumer 605 shall set 603 via an automatic write the bank ID 301 of the shared memory RAM bank that shall be used by the producer from that point forward.

The consumer then re-triggers the reporting timer 600 for the duration of the reporting period.

Since the last access to the shared memory RAM bank 509, a consumer process or thread may have decided to assign a different shared memory RAM bank 509 to the producer, the producer process or thread shall make sure it is using the proper shared memory RAM bank 509 by retrieving the bank ID 301 instead of using a cached bank ID in an internal memory location (not the same as bank ID 301), before attempting to write into a shared memory RAM bank 509. Depending on how the shared memory RAM bank 509 is used, the producer may need to reset an index into the shared memory RAM bank 509 whenever it detects that the bank ID 301 has been switched by a consumer process.

A Producer thread (in Kernel Space 101) receives a new measurement 606 in producer idle state 607. It transitions 609 to producer filling state 610 and uses 604 the current bank ID 302 set by the consumer 605 to fill in the data structures 303. Since the memory has a finite size, the Producer should make sure that it does not exceed the storage capacity of a shared memory RAM bank.

The alternative in FIG. 6 is simpler than the one in FIG. 5 and is ideally suited to scenarios where the consumer has total control over the ownership and state of the shared memory RAM banks The FIG. 5 alternative is more flexible and puts the control of the shared memory RAM banks under the complete responsibility of the Producer.

What is claimed is:

1. A method of exchanging large amounts of memory within an operating system containing consumer and producer threads located in a user space and a kernel space, by controlling ownership of a plurality of RAM banks shared by multiple processes or threads in a consumer-producer relationship, comprising
sharing at least two RAM banks between a consumer process or thread and a producer process or thread, thereby allowing memory to be exchanged between said consumer process or thread and said producer process or thread, and
alternately assigning ownership of a shared RAM bank to either said consumer process or thread or said producer process or thread, thereby allowing said producer process or thread to insert data into said shared RAM bank and said consumer process or thread to access data from said shared RAM bank.

2. The method of claim 1 wherein said shared RAM banks are located in a RAM region shared by said user space and kernel space, with each said RAM bank containing definitions including
a bank identifier comprised of a base address or a numerical index,
an owner flag used to identify the process or thread currently owning said bank, and
a data region structured to allow memory exchange.

3. The method of claim 1 wherein said consumer process or thread assigns ownership of said shared RAM bank to said producer process or thread.

4. The method of claim 3 wherein a consumer process or thread assigns ownership of said shared RAM bank to a producer process or thread by setting the current memory bank identifier to a new value via an automatic update.

5. The method of claim 3 wherein a consumer process or thread assigns ownership of said shared RAM bank to a producer process or thread based on an external event comprising
the expiration of a reporting timer initiated by said consumer process or thread and receiving an asynchronous event notification upon expiration of said reporting timer, or
a request from a management thread or process.

6. The method of claim 3 wherein said producer process or thread detects said assignment of said shared RAM bank by
retrieving the bank identifier and comparing the bank identifier against a cached copy of the previously used bank identifier, or
detecting whether the bank identifier has changed, and resetting the bank index to the beginning of the data region of the bank if the bank identifier has changed.

7. The method of claim 1 wherein said producer process or thread assigns ownership of said shared RAM bank to said consumer process or thread.

8. The method of claim 7 wherein a producer process or thread assigns ownership of said shared RAM bank to a consumer process or thread based on an external event comprising
a timer initiated by said producer process or thread,
an asynchronous event notification sent from said producer process or thread to said consumer process or thread, or
a request from a management thread or process.

9. The method of claim 7 wherein said consumer process or thread detects said assignment of said shared RAM bank by
receiving an asynchronous notification from a producer process or thread,
accessing the bank identifier, or
resetting the bank index to the beginning of the data region of the bank.

10. A system for exchanging large amounts of memory within an operating system containing consumer and producer threads located in a user space and a kernel space, by controlling ownership of a plurality of RAM banks shared by multiple processes or threads in a consumer-producer relationship, comprising a processor adapted to
share at least two RAM banks between a consumer process or thread and a producer process or thread, thereby allowing memory to be exchanged between said consumer process or thread and said producer process or thread, and
alternately assign ownership of a shared RAM bank to either said consumer process or thread or said producer process or thread, thereby allowing said producer process or thread to insert data into said shared RAM bank and said consumer process or thread to access data from said shared RAM bank.

11. The system of claim 10 wherein said shared RAM banks are located in a RAM region shared by said user space and kernel space, with each said RAM bank containing definitions including
a bank identifier comprised of a base address or a numerical index,
an owner flag used to identify the process or thread currently owning said bank, and
a data region structured to allow memory exchange.

12. The system of claim 10 wherein said consumer process or thread assigns ownership of said shared RAM bank to said producer process or thread.

13. The system of claim 12 wherein a consumer process or thread assigns ownership of said shared RAM bank to a producer process or thread by setting the current memory bank identifier to a new value via an automatic update.

14. The system of claim 12 wherein a consumer process or thread assigns ownership of said shared RAM bank to a producer process or thread based on an external event comprising
the expiration of a reporting timer initiated by said consumer process or thread and receiving an asynchronous event notification upon expiration of said reporting timer, or a request from a management thread or process.

15. The system of claim 12 wherein said producer process or thread detects said assignment of said shared RAM bank by
retrieving the bank identifier and comparing the bank identifier against a cached copy of the previously used bank identifier, or
detecting whether the bank identifier has changed, and resetting the bank index to the beginning of the data region of the bank if the bank identifier has changed.

16. The system of claim 10 wherein said producer process or thread assigns ownership of said shared RAM bank to said consumer process or thread.

17. The system of claim 16 wherein a producer process or thread assigns ownership of said shared RAM bank to a consumer process or thread based on an external event comprising
a timer initiated by said producer process or thread,
an asynchronous event notification sent from said producer process or thread to said consumer process or thread, or
a request from a management thread or process.

18. The system of claim 16 wherein said consumer process or thread detects said assignment of said shared RAM bank by
receiving an asynchronous notification from a producer process or thread,
accessing the bank identifier, or
resetting the bank index to the beginning of the data region of the bank.
